(19) United States
(12) Patent Application Publication
(10) Pub. No.: US 2018/0338612 A1
(43) Pub. Date: Nov. 29, 2018

(54) SECURE-A-SEAT

(71) Applicant: Michael Thompson, Slaton, TX (US)

(72) Inventor: Michael Thompson, Slaton, TX (US)

(21) Appl. No.: 15/989,155

(22) Filed: May 24, 2018

Related U.S. Application Data
(60) Provisional application No. 62/510,695, filed on May 24, 2017.

(51) Int. Cl. A47B 83/02; F16M 13/02

(52) U.S. Cl. CPC A47B 83/021; F16M 13/02

(57) ABSTRACT

A system for securing a chair to a table is disclosed herein. The system for securing a chair to a table prevents small or young children from operating the chair in an unsafe manner. The chair is connected to the table through a removable and retractable band. Also disclosed are related methods.

### CROSS REFERENCE TO RELATED APPLICATION

The present application is related to and claims priority to U.S. Provisional Patent Application No. 62/510,695 filed May 24, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of chairs and more specifically relates to chairs secured to tables.

### 2. Description of Related Art

Children are often rambunctious and may accidentally injure themselves. Some children may stand up on chairs and climb or attempt to climb on a table. Children may make their way onto the table and become at risk for falling from a considerable height, causing them serious injury. Further, outdoor tables and chairs may be susceptible to high winds and end up blowing away. A suitable solution is desired.

U.S. Pat. No. 8,646,743 to Thomas Salerno relates to a safety strap set for preventing toddlers from climbing on a chair. The described safety strap set for preventing toddlers from climbing on a chair includes a child-safety attachment device that is adapted to maintain a self-standing chair secure to a self-standing surface or table such that the seat of the chair is unable to be used by a child as a climbing tool and contains two attachment sets, each comprising a surface attachment part, a length adjustable chair attachment part detachably attachable to the chair, and both parts detachably attachable to each other, such that the chair is held securely to the surface when each end of the surface attachment parts is attached to the surface and the chair attachment part is attached to the chair and the two parts attach to each other.

### BRIEF SUMMARY OF THE INVENTION

In view of the foregoing disadvantages inherent in the known chair art, the present disclosure provides a novel Secure-A-Seat. The general purpose of the present disclosure, which will be described subsequently in greater detail, is to provide a system for securing a chair to a table to prevent small children from operating the chair in an unsafe manner. Also disclosed are related methods.

A system for securing a chair to a table is disclosed herein. The system for securing a chair to a table includes securing a chair to a table comprising: a housing; a mount on the outer surface of the housing to connect the housing to the underside of the table; a spool within the housing; a band wound on the spool such that two spool ends unspool at the same rate, wherein the band is adapted to wrap around part of the chair or adapted to hook to the chair.

A method of using the system for securing a chair to a table is also disclosed herein. The method of using the system for securing a chair to a table may comprise the steps of providing the above system, mounting the system to a table, and connecting band ends to a chair.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a Secure-A-Seat, constructed and operative according to the teachings of the present disclosure.

FIG. 1 is a perspective view of the system for securing a chair to a table during an ‘in-use’ condition, according to an embodiment of the disclosure.

FIG. 2 is a perspective view of the system for securing a chair to a table of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to chairs and more particularly to a Secure-A-Seat as used to improve the safety of young children and secure outdoor furniture with respect to high winds or other inclement weather.

Generally, many people have outdoor furniture. Outdoor furniture is a type of furniture specifically designed for outdoor use. It is typically made of weather-resistant materials such as aluminum, which does not rust. The most commonly sold types of outdoor furniture are made of plastic, wood, aluminum, wicker, and wrought iron. The present invention provides users with a retractable band system capable of locking chairs in place underneath a table. This prevents chairs from being pulled too far outward, which could allow young children to use the chair as a climbing aid. It firmly secures the chair to a table, eliminating the worry of a child injuring themselves by crawling on the furniture and pulling it over. The disclosed devices install conveniently on most types of table and chair sets. The present invention functions to secure outdoor chairs and tables together, preventing furniture from blowing away during inclement weather.

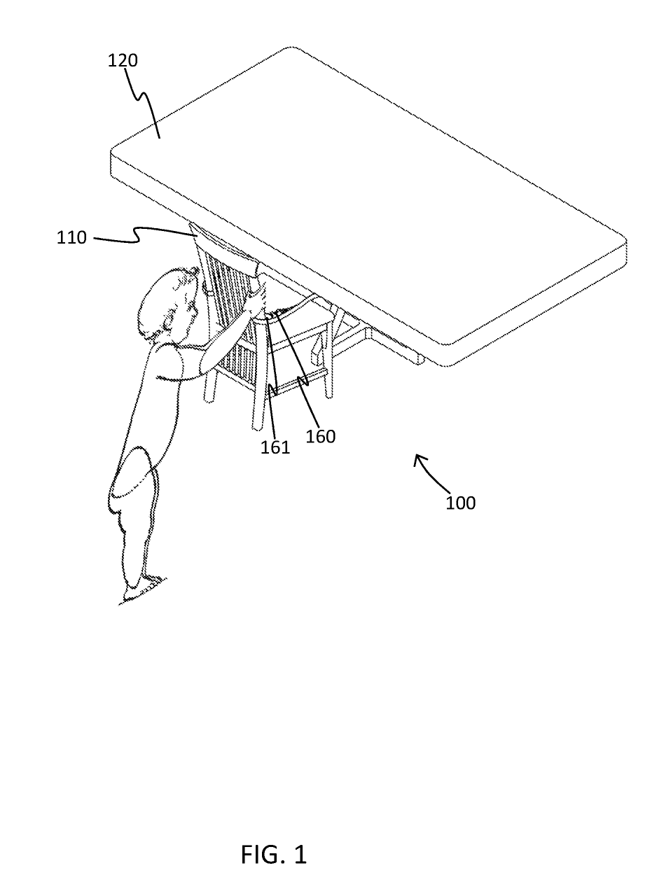

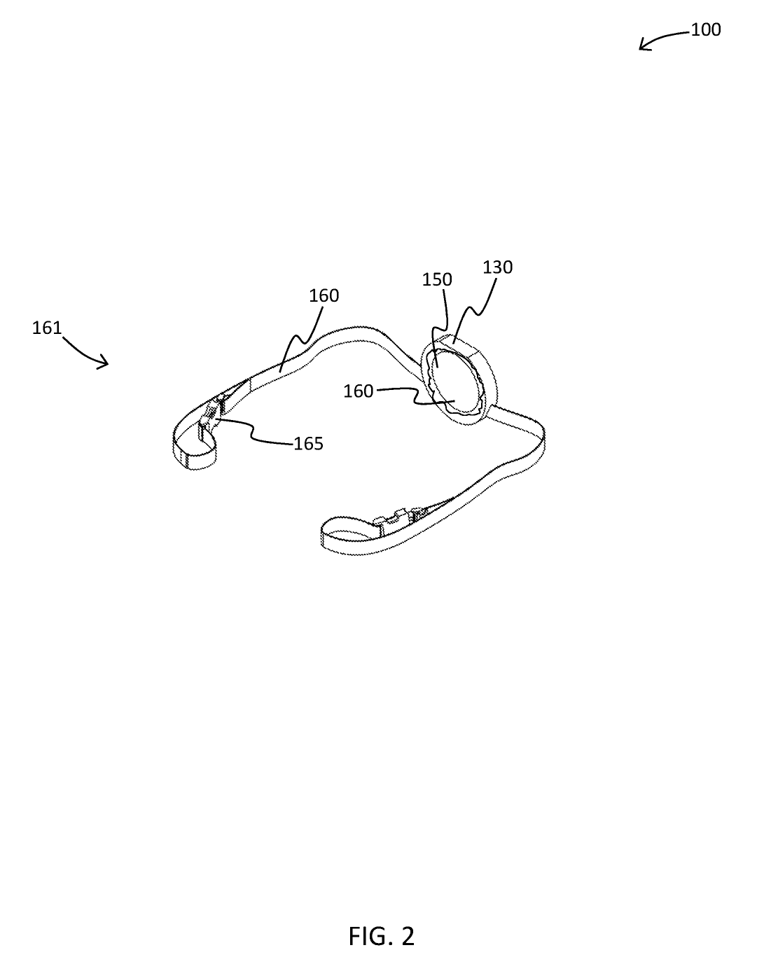

Referring now to FIGS. 1-2, the Secure-A-Seat is a system with a retractable band capable of securing one or more chairs to a table. The system is intended to extend from underneath a table and secure the chair in place a set distance from the table and to enable children to sit in the chair without being able to stand up on it. The band can extend around the back of the chair and secure the chair to the table. Or the band can connect to the chair. Child safety clasps such as side-release buckles sit near the band ends to prevent children from unhooking the clasps. Users can install the system underneath a table using a sticky adhesive, hook-and-loop fasteners, or screws, etc. Band ends extend outward from the system and go around the side or back of the chair. Band ends can be buckled or clasped together for securement. This system can be installed on standard dining room tables and chairs to hold the chair in place in a child-safe arrangement. The system can also be used with outdoor tables and chairs to prevent their movement during inclement weather. Secure-a-Seat can be constructed using metal, nylon, plastic, and other suitable materials. The band may extend approximately 1 to 1½ feet outward. Exact size, measurement, construction, and design specifications may vary upon manufacturing.

Referring now more specifically to the drawings by numerals of reference, there is shown in FIGS. 1-2, various views of a system for securing a chair to a table. FIG. 1 shows a system for securing chair 110 to table 120 during an ‘in-use’, according to an embodiment of the present disclosure. As illustrated, system 100 may include housing 130, mount 140, spool 150, and band 160. In some embodiments, band 160 is wound around spool 150 and placed into housing 130. Using this system impedes a young child's ability to move the chair or to use the chair as a climbing platform.

FIG. 2 shows a perspective view of the system's for securing chair 110 to table 120 of FIG. 1, according to an embodiment of the present disclosure. As above, the system for securing chair 110 to table 120 may include a housing 130, a mount 140, a spool 150, and band 160. In this embodiment, band 160 is configured to wrap around part of a chair, such as legs, armrests, mid rails, lower rails, stretchers, spindles, stiles, etc.

In embodiments like the one depicted in FIG. 2, band 160 has connectors 165 at band 160's terminal ends 161. Connector 165 makes band end 161's connection to table 120 reversible. Connector 165 can be any type of suitable connector as is well known to those of ordinary skill in the art. It some versions, connector 165 is a tie, a buckle, a side-release buckle (shown in FIG. 2), a hook-and-loop fastener, a hook, a clasp, a magnet, etc. Connector 165 can comprise material selected from plastic, fabric, metal, wood, etc.

Band 160 is flexible in some embodiments. And the length of band 160 is adjustable. In particular versions, band 160 has a length that is from 1-10, 1-5, 2-4 feet, etc. In these or other versions, band 160 protrudes from housing 130 through at least two positions. Band 160 can contain webbing, belts, cords, tapes, cables, etc. Band 160 can comprise material selected from plastic, fabric, metal, etc.

Housing 130 contains spool 150 and slots to accommodate band 160. In some versions, spool 150 contains a retracting device, such as devices actuated by springs. Band 160 wraps or winds around spool 150 and the retracting device allows band 160 to extend and retract. Thus, in some versions band ends 161 are retractable.

Mount 140 sits on the outside of housing 130 and housing 130 contacts or mounts to table 120 at the position of mount 140. Mount 140 connects to table 120 using adhesives, hook-and-loop fasteners, or screws, etc.

In use, housing 130 is mounted underneath table 100 at the position of mount 140. Band 160 can extend from housing 130 and band end 161 can be connected to chair 110 using connection 165 or looped completely around chair 110. Chair 110 is properly positioned vis-à-vis table 120 and spool 150 applies a biasing force that holds chair 110 to table 120; the chair firmly contacts the table. This makes the seat part of chair 110 inaccessible to young child and this prevents the child from maneuvering chair 110 into a position to be used as a climbing platform. When chair 110 is intended to be used for sitting, connection 165 can be opened and the biasing source within spool 150 will facilitate band 160's retraction into housing 130 and onto spool 150.

It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for the system for securing a chair to table 120 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A system for securing a chair to a table comprising:
a housing;
a mount on an outer surface of the housing configured to connect the housing to an underside of the table;
a spool within the housing; and
a band wound on the spool such that two band ends unspool at the same rate,
wherein the ends are configured to wrap around part of the chair and alternatively configured to hook to the chair.

2. The system of claim 1, wherein the connection comprises hook-and-loop fasteners, adhesives, and alternatively screws.

3. The system of claim 2, wherein the band has an adjustable length.

4. The system of claim 3, wherein the band has a length of from 1 to 1½ feet.

5. The system of claim 4, wherein the band is retractable.

6. The system of claim 5, wherein a material of the band is selected from webbing, belts, cords, tapes, and cables.

7. The system of claim 1, wherein the spool comprises a retracting assembly.

8. A system for securing a chair to a table comprising:
a housing;
a mount on an outer surface of the housing configured to connect the housing to an underside of the table with a connection that comprises hook-and-loop fasteners, adhesives, and alternatively screws;
a spool with a retracting assembly within the housing; and
a retractable band wound on the spool such that two band ends unspool at the same rate,
wherein
the spool is adapted to bias the ends such that the chair firmly contacts the table,
and
a material of the band is selected from webbing, belts, cords, tapes, and cables.

9. A method of securing a chair to a table comprising the steps of:
providing the system of claim 1;
connecting band ends to the chair and alternatively around the chair;
and
placing the chair near the table,
wherein the spool is configured to secure the chair against the table.

10. The method of claim 9 further comprising a connection between the table and the housing that comprises hook-and-loop fasteners, adhesives, and alternatively screws, and wherein
the spool has a retracting assembly and is configured to bias the ends such that the chair firmly contacts the table,
and
the band is retractable, and a material of the band is selected from webbing, belts, cords, tapes, and cables.
